(19) United States
(12) Patent Application Publication
(10) Pub. No.: US 2026/0112172 A1
(43) Pub. Date: Apr. 23, 2026

(54) Sweep and Marker Detection System

(71) Applicant: Batfer Investment S.A., Montevideo (UY)

(72) Inventor: Emiliano Schifrin, Buenos Aires (AR)

(21) Appl. No.: 19/359,848

(22) Filed: Oct. 16, 2025

Related U.S. Application Data
(60) Provisional application No. 63/708,453, filed on Oct. 17, 2024.

(51) Int. Cl. G06V 20/52; G06V 10/56

(52) U.S. Cl. CPC G06V 20/52; G06V 10/56

(57) ABSTRACT

A system for detecting colored sweep and marker fluid and drilling fluid and for routing the respective fluids to either a first or second tank. The system includes two cameras for watching the flows entering the two tanks. A controller connected to the cameras processes the video feeds from the cameras and detects a change in color signaling the presence or absence of the sweep and marker fluid. The valves are opened or closed to direct the fluid to the correct tank based on the color of the fluid.

### CROSS REFERENCE TO RELATED APPLICATION

This application claims priority to U.S. Application No. 63/708,453 filed on Oct. 17, 2024, the disclosure of which is incorporated herein by reference for all purposes.

### FIELD OF THE INVENTION

The present invention relates to an automated sweep detection system for use in oil and gas operations.

### BACKGROUND OF THE INVENTION

A closed loop drilling fluid system employs a sequence of storage tanks and solids control equipment to eliminate drill cuttings from the drilling fluid once they have been transported out of the wellbore during the drilling process. As part of this process, sweep and marker fluids are injected upstream of the well. Sweep is a specialized drilling fluid formulated to transport cuttings from the wellbore. The density and viscosity of the sweep can be adjusted as needed to effectively clean the wellbore. Marker is a special fluid used to signal when the drilled plug has ascended to the surface. It is typically a blue or red color which is readily distinguishable from the water in the well. Marker does not mix with the water so as to remain visually detectable. In prior art systems, the marker is visually detected by the cite personnel and the fluids rerouted using manual processes.

### SUMMARY OF THE INVENTION

In one aspect, the present invention relates to a system for detecting the sweep/marker fluid in a closed loop system.

In another aspect, the present invention relates to a system for automatically detecting the presence sweep/marker fluid in a closed loop system and for automatically directing such fluid to a storage tank.

In a further aspect, the present invention relates to a system for automatically detecting the presence of the regular drilling fluid in a closed loop system and for automatically directing such fluid to a sand separator.

### BRIEF DESCRIPTION OF THE DRAWINGS

FIG. 1 is a schematic of a typical prior art closed loop drilling system.

FIG. 2 is a schematic of the sweep detection system of the present invention.

FIG. 3 depicts one embodiment of the present invention.

FIG. 4 is an environmental depiction of the embodiment of FIG. 3.

FIG. 5 is a depiction of the fluid flow when the marker is not visible.

FIG. 6 is a depiction of the color recognition program of the present invention.

### DETAILED DESCRIPTION OF PREFERRED EMBODIMENTS

Embodiments of the invention are described more fully hereafter with reference to the accompanying drawings. Elements that are identified using the same or similar reference characters refer to the same or similar elements which perform the same functions across various embodiments. The various embodiments of the invention may, however, be embodied in many different forms and should not be construed as limited to the embodiments set forth herein. Rather, these embodiments are provided so that this disclosure will be thorough and complete, and will fully convey the scope of the invention to those skilled in the art.

As used herein the term “brown fluid” is intended to refer to the fluid that typically flows from the well and which does not contain the sweep/marker. The color may not necessarily be brown. As used herein the term “colored fluid” is intended to refer to the sweep/marker fluid which has been dyed a visually distinct color, often a shade blue or red, but it could be another color. The term is intended to differentiate from the “brown fluid” (though brown is technically a color) as defined above.

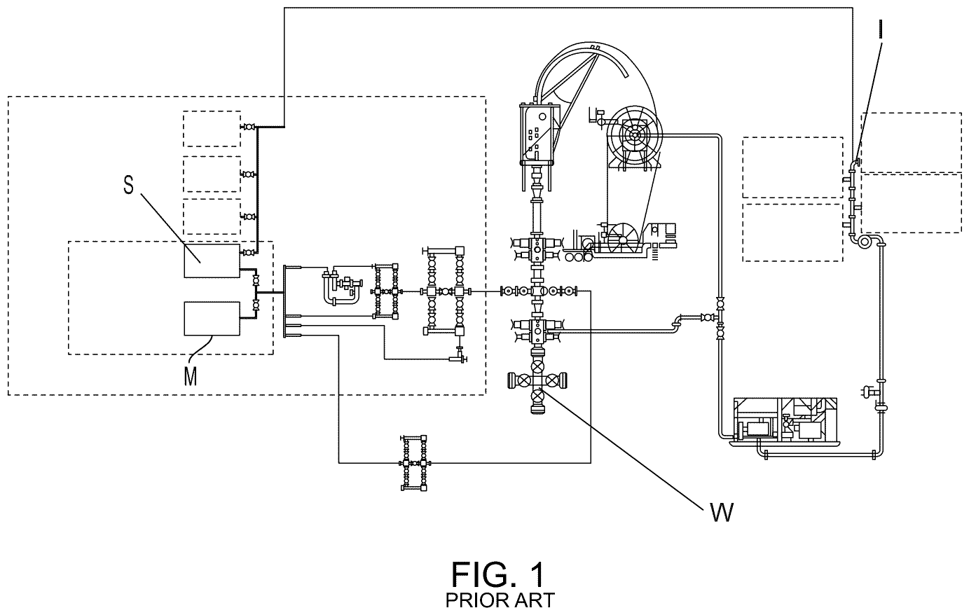

Turning first to FIG. 1, there is shown a schematic of a typical prior art closed loop drilling circuit. As part of this process, sweep and marker fluids are injected upstream of the well W at injection site I.

Once the marker and sweep reach the surface, they must be promptly removed from the closed water circuit to prevent dilution. This ensures that another marker/sweep bump can be injected and detected effectively. There are typically two tanks positioned downstream of the well W. One tank is a sand separator system S, while the other tank M is for storing the marker once it emerges at the surface. To separate the marker, the process is typically conducted manually, involving a visual inspection by personnel to determine when the colored marker reaches the surface. Utilizing a valve manifold V, the switch is then made to the marker storage tank M, allowing the fluid to flow into it until the colored fluid is no longer visible. At this juncture, the switch is then manually reverted back to the sand separator tank S.

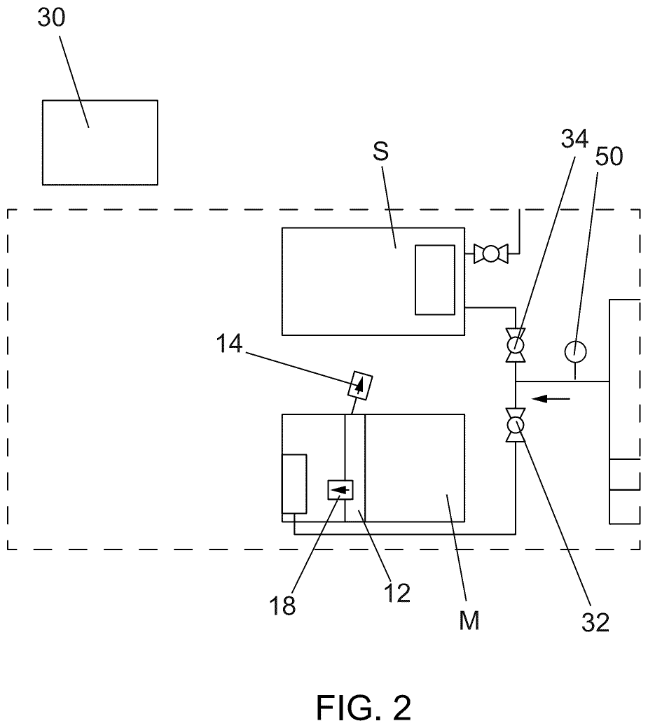

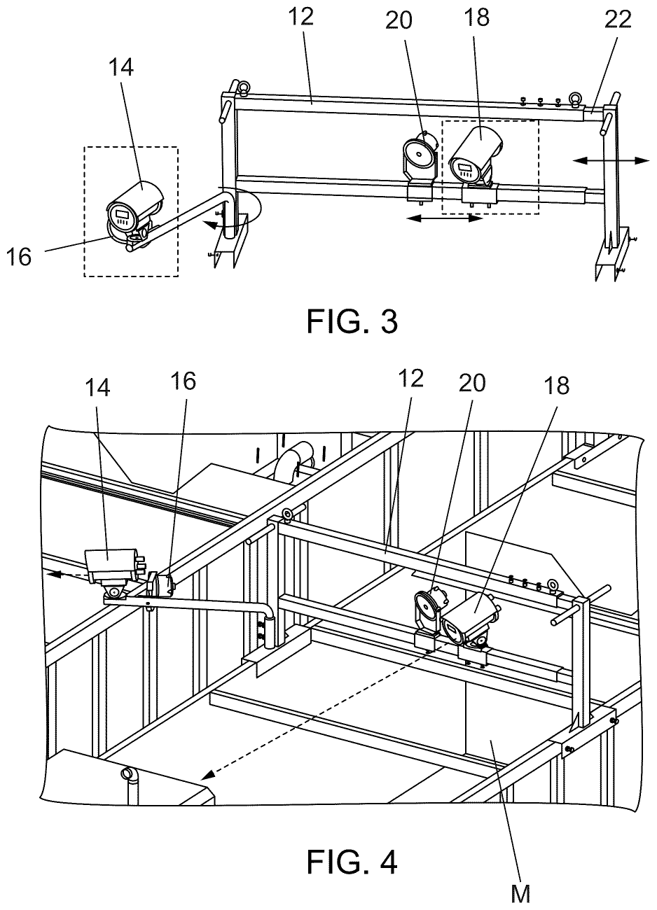

Turning to FIGS. 2-4, there is shown one embodiment of the automated sweep and marker detection system 10. The system 10 comprises a skid 12 on which are mounted a first camera 14, a first light 16, a second camera 18, and a second light 20. First camera 14 is preferably pivotally mounted to skid 12 and is positioned to monitor the fluid entering the sand separation tank S. Second camera 18 is preferably slidably mounted on skid 12 and is positioned to monitor the fluid entering the sweep/marker storage tank M. As seen in FIG. 4, the skid 12 can be positioned atop the open storage tank M. The preferred mounting of first and second cameras 14 and 18 allow for monitoring both tanks from a single skid. The cameras being movable on the skid allows for the installation of the skid on system of varying configurations. In a preferred embodiment, skid 12 has a telescoping frame 22 which can account for varying sizes of tanks. Thus, if desired, both cameras can be slidable and pivotable to maximize the areas available for viewing. It will be appreciated though that the two cameras may be mounted differently, including the skid being mounted on sand separation tank S, or one camera each mounted separately atop its designated tank to be monitored.

In a preferred embodiment, light 16 is mounted near camera 14 and can thus shine on the area being monitored by camera 14. Likewise, light 20 is mounted near camera 18 and is also slidable along skid 12. Alternatively, lights may be incorporated into the cameras themselves.

A controller 30 is operatively connected to the cameras. The cameras send video feeds, both in color, to controller 30. Preferably the video feed is sent as a live feed to controller 30, i.e., there is no delay between the events monitored by the camera and the controller 30 receiving the feed. Controller 30 is programmed with an analytical model designed to detect color changes in the fluid. In a preferred embodiment, the controller 30 also operates lights 16 and 20 and automatically activates them when additional illumination is required. Upon detection of preprogrammed color change criteria in the fluid, the control panel automatically triggers an opening/closing sequence in the valves 32 and 34. Valves 32 and 34 may be pneumatically, hydraulically, or electronically controlled. Valves 32 and 34 may also have a manual control option in case of power failure or emergency shutdown. Valves 32 and 34 may be of the same type or differing types, but preferably they are both the same.

It will be appreciated that the system may also operate with only one valve which can be opened or closed to redirect the fluid. It will be further appreciated that connections, conduits, cables, and the like are required for the operation of the present system. Such features are well known to those skilled in the art and are not described in detail herein.

The default positions are for valve 32 to be closed and valve 34 to be open. This ensures that the (typically) brown fluid from the well flows into the sand separator tank S. When controller 30 detects the presence of the colored marker through first camera 14, it will automatically initiate the closing of valve 34 and the opening of valve 32. This will direct the colored fluid to the sweep/marker storage tank M. When controller 30 detects the return of the brown colored fluid through second camera 18, the valve configuration is returned to the default (valve 32 closed and valve 34 open) and the fluid once again is sent to the sand separation tank S.

The controller 30 of the present invention preferably utilizes a neural network which has been taught through a supervised dataset to recognize and classify colors in images or other forms of visual data. Each example in the dataset includes an image along with a label indicating the predominant color present in the image, such as red, blue, green, etc. During training, the neural network learns to identify visual patterns corresponding to different colors, adjusting its internal parameters to correctly associate visual features with the correct color labels. For example, if a neural network is programmed to identify the color blue in an image, the supervised dataset would contain images with objects or areas of the image that are predominantly blue, along with the associated “blue” label. The neural network would learn to detect common visual features in the images that indicate the presence of blue, such as the presence of blue pixels with certain spatial distributions or texture characteristics. Once the neural network has been successfully trained, it can be used to analyze new images and accurately predict the predominant color in each one. In short, a supervised dataset provides the necessary examples to teach the neural network to recognize and classify different colors in visual data.

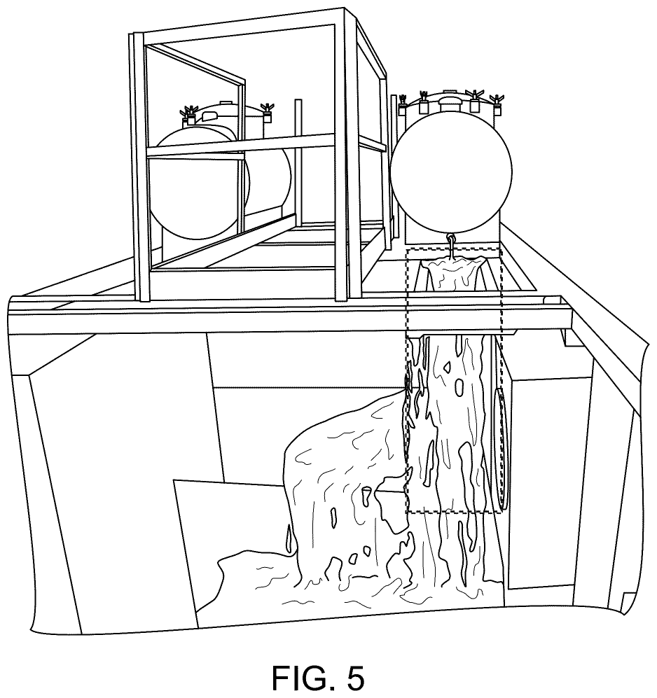

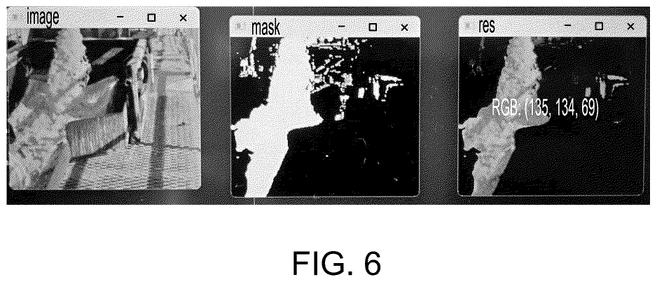

FIG. 5 depicts the flow of brown fluid into a tank. The area in a dotted line is analyzed for potential color changes. FIG. 6 shows examples of the system identifying a color and assigning it a code. It will be appreciated that the exact color and system of assigning a color code can vary.

The system of the present invention is preferably also programmed to transmit the video feeds of the first and second cameras 14 and 18, and data regarding the storage of the sweep/marker fluid to user monitors or other mobile devices, as desired by the user. If desired, the system can be programmed to simply alert personnel through a visual and/or audio alert when the marker fluid is detected and the personnel can initiate the valve change themselves, rather than having the controller initiate the valve changes. In another embodiment, the personnel may simply monitor the cameras themselves and upon viewing a change in color, they may initiate the necessary valve changes.

In another embodiment, there is a density sensor 50 disposed along the line upstream of valves 32 and 34. The density sensor 50 is connected to controller 30 and transmits information about the density of the fluid in the line. The sweep and marker fluid has a distinctive density from the rest of the production fluid. When the density sensor 50 detects a change in density, controller 30 then initiates the changes of the valve configuration. When the density sensor 50 detects that the density has returned to the typical range, controller 30 then initiates valves 32 and 34 to return to the original configuration. Density sensor 50 can be used to supplement the visual analysis provided through the cameras and the controllers, or if needed, can be used instead of the visual analysis (for example if one or more cameras is in need of repair or has gotten dirty and unable to transmit a clear feed).

The system of the present invention has several advantages. The system is an innovative and efficient solution for detecting sweep and markers and for controlling the fluid flows into different tanks. Being fully automatable, the system can operate independently, thus improving safety and reducing costs.

Although specific embodiments of the invention have been described herein in some detail, this has been done solely for the purposes of explaining the various aspects of the invention and is not intended to limit the scope of the invention as defined in the claims which follow. Those skilled in the art will understand that the embodiment shown and described is exemplary, and various other substitutions, alterations and modifications, including but not limited to those design alternatives specifically discussed herein, may be made in the practice of the invention without departing from its scope.

What is claimed is:

1. A system for detecting sweep and marker fluid in drilling fluid and for routing the respective fluids to either a first or second tank, comprising:
a conduit from a wellhead wherein drilling fluid and sweep and marker fluid can flow from said wellhead;
at least one valve disposed along said conduit which when in an open position directs any fluid in said conduit to said first tank, and when in a closed position directs any fluid in said conduit to said second tank;
a first camera pivotally monitoring any fluid flow into said first tank and producing a first video feed;
a second camera monitoring any fluid flowing into said second tank and producing a second video feed;
a controller operatively connected to said first and second cameras and operatively connected to said at least one valve, wherein said controller is programmed to analyze the first and second video feeds and detect a change in color in any fluid flow shown in the video feeds and to open or close said at least one valve in response to said change in color.

2. The system of claim 1, wherein said first and second cameras are mounted on a skid which in turn is mounted on either said first or second tank.

3. The system of claim 2 wherein at least one of said first and second cameras is slidably mounted on said skid.

4. The system of claim 2 wherein at least one of said first and second cameras is pivotably mounted on said skid.

5. The system of claim 1 wherein said first tank is a sand separation tank and said second tank is a storage tank, and said controller is programmed to detect brown fluid and colored fluid from said conduit and operate said at least one valve to direct said brown fluid to said sand separation tank, and direct said colored fluid to said storage tank.

6. The system of claim 1, comprising first and second valves disposed along said conduit, wherein in a first valve configuration, said first valve is open and said second valve is closed, thereby directing any fluid in said conduit to said first tank;
whereby in a second valve configuration, said first valve is closed and said second valve is open, thereby directing any fluid in said conduit to said second tank; and
wherein said controller is operatively connected to said first and second cameras and is operatively connected to said first and second valves, wherein said controller is programmed to analyze the first and second video feeds and detect a change in color in any fluid flow and change valve configuration in response to said change in color.

7. The system of claim 6, wherein said first tank is a sand separation tank and said second tank is a storage tank, and said controller is programmed to detect brown fluid and colored fluid from said conduit and operate said first and second valves to direct said brown fluid to said sand separation tank, and direct said colored fluid to said storage tank.

8. A system for detecting sweep and marker fluid in drilling fluid and for routing the respective fluids to either a first or second tank, comprising:
a conduit from a wellhead wherein drilling fluid and sweep and marker fluid can flow from said wellhead;
at least one valve disposed along said conduit which when in an open position directs any fluid in said conduit to said first tank, and when in a closed position directs any fluid in said conduit to said second tank;
a first camera pivotally monitoring any fluid flow into said first tank and producing a first video feed;
a second camera monitoring any fluid flowing into said second tank and producing a second video feed;
at least one valve which when open sends fluid to said first tank and when closed sends fluid to said second tank;
a controller operatively connected to said first and second cameras, wherein said controller is programmed to analyze the first and second video feeds and detect a change in color in any fluid flow shown in the video feeds and to generate an audio or visual alert of the change in color, whereby a user can open or close said at least one valve.

9. The system of claim 8, wherein said first and second cameras are mounted on a skid which in turn is mounted on either said first or second tank.

10. The system of claim 9, wherein at least one of said first and second cameras is slidably mounted on said skid.

11. The system of claim 9, wherein at least one of said first and second cameras is pivotably mounted on said skid.

12. The system of claim 8 wherein said first tank is a sand separation tank and said second tank is a storage tank, and said controller is programmed to detect brown fluid and colored fluid from said conduit, and said user operates said at least one valve to direct said brown fluid to said sand separation tank, and direct said colored fluid to said storage tank.

13. The system of claim 8, comprising first and second valves disposed along said conduit, wherein in a first valve configuration, said first valve is open and said second valve is closed, thereby directing any fluid in said conduit to said first tank;
whereby in a second valve configuration, said first valve is closed and said second valve is open, thereby directing any fluid in said conduit to said second tank.

14. The system of claim 13, wherein said first tank is a sand separation tank and said second tank is a storage tank.

15. A system for detecting sweep and marker fluid in drilling fluid and for routing the respective fluids to either a first or second tank, comprising:
a conduit from a wellhead wherein drilling fluid and sweep and marker fluid can flow from said wellhead;
at least one valve disposed along said conduit which when in an open position directs any fluid in said conduit to said first tank, and when in a closed position directs any fluid in said conduit to said second tank;
a density senser disposed along said conduit, upstream of said at least one valve;
a controller operatively connected to said density sensor and to said at least one valve, wherein said controller is programmed to analyze the density readings from said density sensor and detect a change in density in any fluid flow shown in the video feeds and to open or close said at least one valve in response to said change in density.

16. The system of claim 15, comprising first and second valves disposed along said conduit, wherein in a first valve configuration, said first valve is open and said second valve is closed, thereby directing any fluid in said conduit to said first tank;
whereby in a second valve configuration, said first valve is closed and said second valve is open, thereby directing any fluid in said conduit to said second tank; and
wherein said controller is operatively connected to said density sensor and to said first and second valves, wherein said controller is programmed to analyze the density readings from said density sensor and detect a change in density in any fluid flow shown in the video feeds and to change the valve configuration in response to said change in density.
